(19) United States
(12) Patent Application Publication
(10) Pub. No.: US 2016/0378894 A1
(43) Pub. Date: Dec. 29, 2016

(54) METHOD AND APPARATUS FOR ANALYZING ECONOMICS OF POWER DEMAND MANAGEMENT BUSINESS PROJECT USING SMART POWER DEMAND RESOURCES MODELING DATA SIMULATION MODULE

(71) Applicant: NEMO PARTNERS NEC, Seoul (KR)

(72) Inventor: Suk-ho YOON, Seoul (KR)

(73) Assignee: NEMO PARTNERS NEC, Seoul (KR)

(21) Appl. No.: 15/182,413

(22) Filed: Jun. 14, 2016

(30) Foreign Application Priority Data
Jun. 26, 2015 (KR) 10-2015-0090929

(51) Int. Cl. G06F 17/50

(52) U.S. Cl. CPC G06F 17/5009; G06F 2217/78

(57) ABSTRACT

An apparatus and a method for analyzing economics of a power demand management business project using a smart power demand resources modeling data simulation module, the apparatus including a cloud computing module for grouping N smart power demand resources modeling data simulation modules according to their positions and IDs through a web application server and connecting the modules to a network, a web application server (WAS) positioned between a cloud computing module and a smart power demand resources modeling data simulation module, and a smart power demand resources modeling data simulation module.

### CROSS-REFERENCE TO RELATED APPLICATION

This application claims priority from Korean Patent Application No. 10-2015-0090929, filed on 26 Jun. 2015, in the Korean Intellectual Property Office, the disclosure of which is incorporated herein by reference in its entirety.

### FIELD OF THE INVENTION

The present invention relates to a method and apparatus for analyzing economics of a power demand management business project using a smart power demand resources modeling data simulation module that is capable of receiving economic analysis information of a power demand management business project in real time in the web, for reducing database load according to economic analysis by processing massive and high-performance data between the web and a cloud server and distributively storing the data as a database through a web cloud computing environment and simulating feedback on a power market for estimating market change caused by injecting power demand resources into a power market and potential, cost, and effect of power demand resources, in the web.

### DISCUSSION OF RELATED ART

Currently, statistical demand resources prediction is a scheme that is widely used to analyze and predict data in various fields.

Time series analysis is a scheme for predicting demand using data obtained by observing an economic phenomenon or a natural phenomenon that changes according to time, and a time series value measured at a specific time point that is dependent upon previous data.

Time-series data has been generated and studied in various fields of economic and management activities.

In particular, power demand prediction as a part of establishment of a business platform for the national virtual power plant is an object required to effectively manage a power plant.

Accuracy power demand prediction is particularly important to predict consumer demand and to trade power as a product.

Currently, as power is used in the lives of everybody, incorrect power demand prediction directly affects those lives.

For example, many companies and users were seriously damaged due to rolling blackouts in September 2011.

Although 30% of a maximum used amount needs to be prepared as backup power, as the supply ability was degraded to 0%, power outages occurred.

Incorrect prediction causes very serious damages such as blackouts from rolling blackouts.

In addition, as power demand has rapidly increased compared with power supply, it is difficult to construct new power supply equipment, and supply from an external source is not easy due to congestion of transmission lines, and accordingly, demand for strategy and business for effectively reducing power demand has increased.

Accordingly, the ability to predict and analyze the characteristics and market mechanism of power demand resources has generally not been available.

In addition, when a domestic power demand resources company wants to run a demand management business under an internal power market environment, it is difficult to analyze economic efficiency and, thus, domestic power market activation is delayed and interest gradually drops off.

A generally relevant document is Korean Patent Publication No. 10-1005050, published 30 Dec. 2010.

### SUMMARY OF EMBODIMENTS OF THE INVENTION

The present invention embodiments are made in view of the above challenges, and it is a purpose of this concept to provide a method and apparatus for analyzing the economics of a power demand management business project using a smart power demand resources modeling data simulation module, for establishing a web cloud computing environment, establishing a base of a future-oriented national demand resources managing system via a design of a mega feedback loop in which power demand resources and power generation resources equally compete with each other so as to accurately manage power demand resources in real time and to enhance a technical level of national power demand management. Also included are simulating bidding data, winning bid data, profit data, and cost data of power demand resources, which are predicted under a power generation market of a power demand resources company, in the form of a web application in real time based on an economic analysis result of a power demand management business project from power demand resources modeling data so as to guide a national power demand resources company to have interest and attention in a national power market.

The above and other purposes are accomplished by the provision of an apparatus for analyzing the economics of a power demand management business project using a smart power demand resources modeling data simulation module. The apparatus includes a cloud computing module for grouping N smart power demand resources modeling data simulation modules according to their positions and IDs through a web application server and connecting the modules to a network, a web application server (WAS) positioned between a cloud computing module and a smart power demand resources modeling data simulation module, and for supporting bidirectional data communication so as to perform a function of dynamic server content between the cloud computing module and the smart power demand resources modeling data simulation module, and a smart power demand resources modeling data simulation module for calling macroscopic modeling of national policy data regarding a stored power demand resources from the cloud computing module through the web application server, establishing power demand resources modeling data so as to compare and analyze economics of the power demand management business project, and then simulating and activating bidding data, winning bid data, profit data, and expense data of power demand resources, predicted under a power generation market of a power demand resources company, on a web image, based on an economic analysis result of the power demand management business project from the power demand resources modeling data.

In accordance with another aspect of the present concept, there is provided a method for analyzing the economics of a power demand management business project using a smart power demand resources modeling data simulation module. The method includes grouping N smart power demand resources modeling data simulation modules according to their positions and IDs through a web application server and connecting the modules to a network, executing dynamic server content between a cloud computing module and a smart power demand resources modeling data simulation module by a web application server (WAS), calling macroscopic modeling of national policy data regarding a stored power demand resources from the cloud computing module through the web application server and establishing power demand resources modeling data so as to compare and analyze economics of the power demand management business project by a smart power demand resources modeling data simulation module, simulating and activating bidding data, winning bid data, profit data, and expense data of power demand resources, predicted under a power generation market of a power demand resources company, on a web image, based on an economic analysis result of the power demand management business project from the power demand resources modeling data by the smart power demand resources modeling data simulation module.

### BRIEF DESCRIPTION OF THE DRAWING

The above and other objects, features, and advantages of the present embodiments will be more clearly understood from the following detailed description when taken in conjunction with the accompanying drawing, in which:

FIG. 1 is a structural diagram illustrating components of an apparatus for analyzing economics of a power demand management business project through a smart power demand resources modeling data simulation module according to the present invention;

FIG. 2 is a block diagram illustrating components of a cloud computing module according to the present invention;

FIG. 3 is a block diagram illustrating components of a cloud tester according to the present invention;

FIG. 4 is a block diagram illustrating components of a cloud data controller according to the present invention;

FIG. 5 is a block diagram illustrating components of a smart power demand resources modeling data simulation module according to the present invention;

FIG. 6 is a block diagram illustrating components of a simulation modeling manager according to the present invention;

FIG. 7 is a block diagram illustrating components of a power demand estimation module according to the present invention:

FIG. 8 is a diagram illustrating a result obtained by classifying a customer type into housing, commercial, and industrial parts and classifying power consumption of an electric device used for each client type into technical potential, economical potential, and maximum achievement potential so as to analyze potential by an energy efficiency program engine unit;

FIG. 9 is a diagram illustrating a graph of an estimation result of power demand resources potential by a power demand resources potential analysis module according to the present invention;

FIG. 10 is a structural diagram illustrating components of a system marginal price (SMP) module according to the present invention;

FIG. 11 is a diagram illustrating a SMP price estimation result through an SMP module according to the present invention:

FIG. 12 is a graph illustrating estimation results of power demand resources and fossil fuel power generation through a power generation and demand resources market analysis module according to the present invention;

FIG. 13 is a graph illustrating an estimation result of cost effect of power demand resources through a power demand resources effect analysis module according to the present invention;

FIG. 14 is a block diagram illustrating components of a smart economic analysis algorithm engine unit according to the present invention;

FIG. 15 is a diagram illustrating components of a demand response market calculation controller according to the present invention;

FIG. 16 is a diagram illustrating components of a financial analysis controller according to the present invention;

FIG. 17 is a diagram illustrating a result obtained by comparing and analyzing reduction for each customer who participates in power demand resources based on preset power demand resources modeling data and then predicted reduction for each customer, according to an embodiment of the present invention;

FIG. 18 is a diagram illustrating a result obtained by comparing and analyzing power demand resources based on preset power demand resources modeling data and predicated sales and net income are formed when power demand resources according to a power demand management business project is traded in a market by a profit analysis controller according to the present invention;

FIG. 19 is a diagram illustrating a result obtained by comparing and analyzing expense consumed for power demand resources according to a power demand management business project based on preset power demand resources modeling data and then predicted operating expense (OPEX), a corporate tax expense, and capital expense for future profit are formed, by an expense analysis controller according to the present invention;

FIG. 20 is a diagram illustrating a result obtained by comparing and analyzing economics of power demand resources according to power demand management business project based on preset power demand resources modeling data and then predicted earnings before interest and taxes (EBIT), a net present value (NPV), an internal ratio of return (IRR), a net cash flow, a B/C ratio, and an accumulated cash flow are formed, by an economic analysis controller according to the present invention;

FIG. 21 is a block diagram illustrating components of a modeling simulation web controller according to the present invention;

FIG. 22 is a flowchart illustrating a method for analyzing economics of a power demand management business project through a smart power demand resources modeling data simulation module according to the present invention; and

FIG. 23 is a diagram illustrating a diagram illustrating a detailed procedure of calling macroscopic modeling of national policy data regarding a stored power demand resources from a cloud computing module through a WAS and forming power demand resources modeling data so as to compare and analyze economics of a power demand management business project by a smart power demand resources modeling data simulation module according to the present invention.

### DETAILED DESCRIPTION OF THE EMBODIMENTS OF THE INVENTION

First, “power demand resources,” modeling data, as used herein, refers to modeled resources, the load of which is capable of being reduced by a demand company or a demand customer in emergency power supply, and this can be generally referred to by the term “NEMO modeling,” which will be more specifically set out shortly below. Such power demand resources modeling data represents reduction obtained by reducing power demand via management in terms of demand (that is, energy efficiency, load management, smart demand response, among others), as resources.

Accordingly, the present invention embodiments may reduce database load according to economic analysis by processing massive and high-performance data between the web and a cloud sever and distributively storing the data as a database through a web cloud computing environment. They may simulate feedback on a power market for estimating market change caused by injecting power demand resources into a power market and potential, cost, and effect of power demand resources, in the web. They may also connect a power demand company and a power demand customer to one power demand resources network through a smart grid so as to establish a smart power demand resources market.

An apparatus for analyzing economics of a power demand management business project may simulate bidding data, winning bid data, profit data, and cost data of power demand resources, which are predicted under a power generation market of a power demand resources company, in the form of a web application in real time through a smart power demand resources modeling data simulation module according to the present invention, based on an economic analysis result of a power demand management business project from power demand resources modeling data.

In addition. NEMO modeling, as sometimes employed herein, is a smart power demand resources modeling data simulation module used in this specification is a combination using “NEMO Partners NEC,” the applicant.

Following from the above, the power demand resources NEMO modeling data used in the specification may include all of first modeling data according to power demand estimation module, second modeling data according to a power demand resources potential analysis module, third modeling data according to a system marginal price (SMP) module, fourth modeling data according to a power generation and demand resources market analysis module, fifth modeling data according to a power demand resources effect analysis module, sixth modeling data according to an automated demand response (ADR) module, and seventh modeling data according to a group method of data handling (GMDH) module.

To be more specific, NEMO modeling includes: modeling data that is the analyzed result from the power demand estimation module 341 that may classify power demand potential in commerce and industry, obtained by considering price elasticity, into load management saving, energy efficiency saving, and self-generation saving and calculate and analyze power demand based on a distribution ratio of past power consumption; modeling data that is the analyzed result from the power demand resources potential analysis module 342 that may analyze potential of power demand management based on power demand potential obtained by considering a rate of economic growth and power price and consumption for each use and an energy saving estimation value predicted through self-generation, among others;

modeling data that is the analyzed result from the SMP module 343 that may simulate power demand resources and power generating resources so as to equally circulate to each other through modeling calculated based on a highest variable ratio and power generation rate of injected fossil fuel generating resources while a power generation rate for each fossil fuel generating resources (coal. LNG, and petroleum) to peak demand except for base load is formed:

modeling data that is the analyzed result from the power generation and demand resources market analysis module 344 that may add power demand resources to an existing power market and analyze a power generating market in which power is generated via competition with fossil fuel generating resources;

modeling data that is the analyzed result from the power demand resources effect analysis module 345 that may estimate profit and existing demand managing program operating expense of a load aggregator (LA) for selling power demand resources, which are generated as the power demand resources are traded on a power market, power generating expense, power transmission and distribution expense, and operating expense (OPEX) of a power transmission and distribution company and predict and analyze unit cost of power according to profit of the power transmission and distribution company;

modeling data that is the analyzed result from the ADR module 346 that is analyzed demand response (DR) market change and business opportunity according to a smart DR system that is being managed by the government from national policy data stored in a data storage module; and

modeling data that is the analyzed result from the GMDH module 347 that is analyzed economic factor (GDP, export, import, number of employed people, economic activity research, and petroleum consumption) and a climate factor (mean temperature), which affect power demand.

Hereinafter, the present concept will be described in detail by explaining exemplary embodiments of the invention with reference to the attached drawings, and the reference numerals set out above will be specifically described.

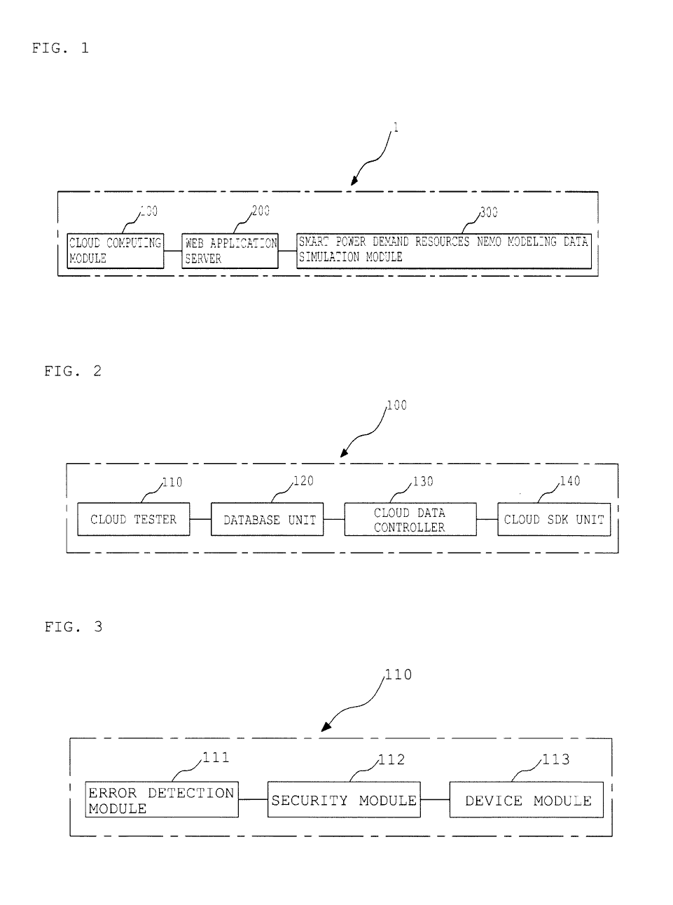

FIG. 1 is a structural diagram illustrating components of an apparatus 1 for analyzing economics of a power demand management business project through a smart power demand resources modeling data simulation module 300 according to the present invention. The apparatus 1 may include a cloud computing module 100, a web application server 200, and the smart power demand resources modeling data simulation module 300.

First, the cloud computing module 100 will be described. Cloud computing module 100 may group N smart power demand resources modeling data simulation modules according to their positions and IDs through the web application server 200 and connect the grouped modules to a network.

As illustrated in FIG. 2, the cloud computing module 100 may include a cloud tester 110, a database unit 120, a cloud data controller 130, and a cloud software development kit (SDK) unit 140.

Cloud tester 110 may examine an error and safety of a smart power demand resources modeling data simulation module so as to directly examine the smart power demand resources modeling data simulation module.

As illustrated in FIG. 3, the cloud tester 110 may include an error detection module 111, a security module 112, and a device module 113.

The error detection module Ill may detect an error in the smart power demand resources modeling data simulation module and transmit content contained in the smart power demand resources modeling data simulation module to the security module 112 when no error is discovered.

The security module 112 may examine the content in the smart power demand resources modeling data simulation module and, then, transmit the content to the device module 113 when the content is normal.

The device module 113 may check use of an abnormal function of the web with the smart power demand resources modeling data simulation module installed therein.

The database unit 120 of FIG. 2 may be connected to a business platform server for the national virtual power plant so as to collect technology data of the national virtual power plant, may be connected to a server of a government organization so as to collect national policy data of power demand resources, shared data of government organizations, domestic power demand resources estimation modeling data, and overseas power demand resources estimation modeling data. It may store a winning bid situation DB for each ordering company, a winning bid situation DB for each license, a winning bid situation DB for each region, a winning bid situation DB for each sum of money, a winning bid situation DB for each quarter, a winning bid situation DB for each month, and a winning bid situation DB for each opening bid time based on a power demand management business project and then, may provide a required database.

The database unit 120 may also include a national virtual power plant technology data DB unit, a national policy data DB unit for power demand resources, a government organization shared data DB unit for power demand resources, a domestic power demand resources estimation modeling data DB unit for power demand resources, an overseas power demand resources estimation modeling data DB unit for power demand resources, a winning bid situation DB unit for each ordering company, a winning bid situation DB unit for each license, a winning bid situation DB unit for each region, a winning bid situation DB unit for each sum of money, a winning bid situation DB unit for each quarter, a winning bid situation DB for each month, a winning bid situation DB unit for each opening bid time, and a national market economic analysis information DB unit.

The national virtual power plant technology data DB unit may store national virtual power plant technology data for each year.

The national policy data DB unit for power demand resources may store national policy data for power demand resources for each year.

The government organization shared data DB unit for power demand resources may store shared data of government organizations for power demand resources for each year.

The domestic power demand resources estimation modeling data DB unit for power demand resources may store domestic power demand resources estimation modeling data for power demand resources for each year.

The overseas power demand resources estimation modeling data DB unit for power demand resources may store overseas power demand resources estimation modeling data for power demand resources for each year.

The winning bid situation DB unit for each ordering company may store data, statistical data, classification data, and analysis data, which are obtained by examining a winning bid result of an ordering organization for each year and a power demand management business project.

The winning bid situation DB unit for license may store data, statistical data, classification data, and analysis data, which are obtained by examining a winning bid result for each power demand license for each year and a power demand management business project.

The winning bid situation DB unit for each region may store data, statistical data, classification data, and analysis data, which are obtained by examining a winning bid result for each region for each year and a power demand management business project.

The winning bid situation DB unit for each sum of money may store data, statistical data, classification data, and analysis data, which are obtained by examining a winning bid result for each sum of money for each year and a power demand management business project.

The winning bid situation DB unit for each quarter may store data, statistical data, classification data, and analysis data, which are obtained by examining a winning bid result for each quarter for each year and a power demand management business project.

The winning bid situation DB unit for each month may store data, statistical data, classification data, and analysis data, which are obtained by examining a winning bid result for each month for each year and a power demand management business project.

The winning bid situation DB unit for each opening bid time may store data, statistical data, classification data, and analysis data, which are obtained by examining a winning bid result for each opening bid time for each year and a power demand management business project.

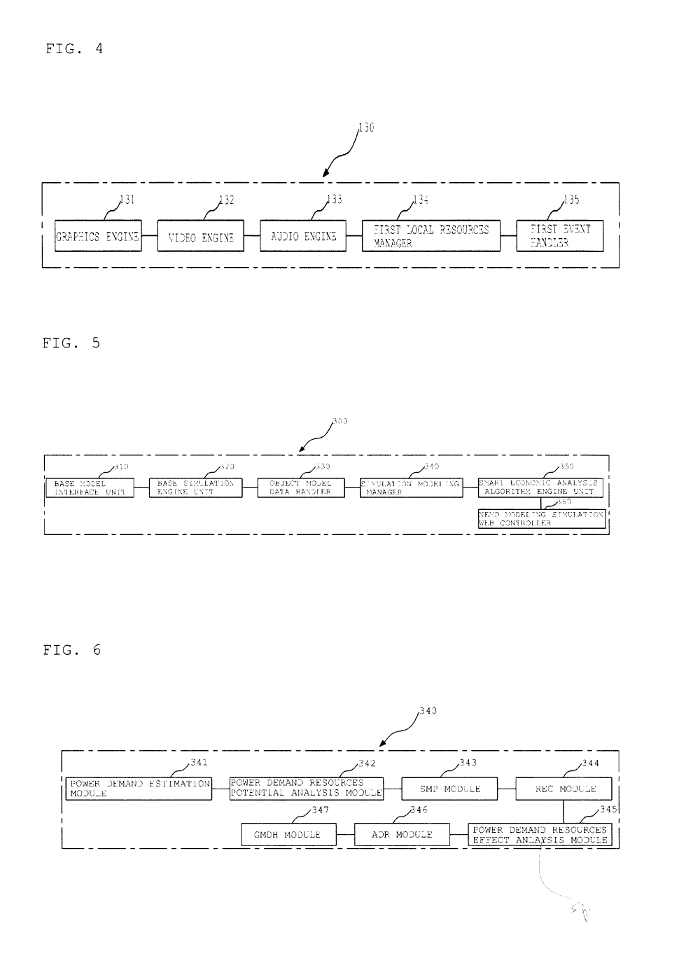

As illustrated in FIG. 4, the cloud data controller 130 may include a graphics engine 131, a video engine 132, an audio engine 133, a first local resources manager 134, and a first event handler 135.

Cloud data controller 130 may apply clouding computing technology to provide a cloud service to the smart power demand resources modeling data simulation module, to detect continuous malicious code and viruses of the smart power demand resources modeling data simulation module, and to store an authentication code of a user of a power demand resources modeling data simulation module.

The graphics engine 131 may perform a basic function of graphics of image processing.

The video engine 132 may process a video reproduction function and transmit each video frame to a cloud application module for economic analysis.

The audio engine 133 may transmit sound reproduced by the smart power demand resources modeling data simulation module to the smart power demand resources modeling data simulation module.

The first local resources manager 134 may process resources information and download of a webpage of a client.

The first event handler 135 may process an event received from the smart power demand resources NEMO modeling data simulation module.

Cloud SDK unit 140 of FIG. 2 may generate a new smart power demand resources modeling data simulation module to be overwritten to update the smart power demand resources modeling data simulation module by establishing, editing, and correcting a development environment of the smart power demand resources modeling data simulation module according to user purpose, and transmit the new smart power demand resources modeling data simulation module to the smart power demand resources modeling data simulation module to be overwritten to update the smart power demand resources modeling data simulation module.

The cloud SDK unit 140 may provide APIs for developing a new cloud application module for economic analysis. That is, a function provided by a lower layer may be wrapped and a GUI component is edited and corrected to generate the new smart power demand resources modeling data simulation module.

The web application server (WAS) 200 of FIG. 1 may be positioned between a cloud computing module and a smart power demand resources modeling data simulation module and may support bidirectional data communication so as to perform a function of dynamic server content between the cloud computing module and the smart power demand resources modeling data simulation module 300.

The web application server (WAS) 200 may transmit HTML or an object using HTTP according to a client request, may execute an application on a user computer or device through HTTP in the internet and may be configured according to Java-based Java EE standard so as to perform a function of dynamic server content.

The web application server (WAS) 200 may be configured to perform a function of connecting an execution environment of the smart power demand resources modeling data simulation module and a database unit of a cloud computing module and a business logic function of managing a plurality of transactions and handling business.

That is, when a create terminal button is executed in a cloud application controller installed in the smart power demand resources modeling data simulation module, the smart power demand resources modeling data simulation module may be connected to the database unit of the cloud computing module through a web application server (WAS) based on a URL of a database unit, a driver, a client name and code, a ratio of a transaction, an execution type of a transaction, and so on, which are pre-input from a client.

In addition, when a start transaction button is executed, the cloud computing module may be requested for HttpPost or HttpGet based on a defined transaction.

Here, HttpPost may be used during a transaction operation such as Insert or Update when a client inputs a value to the cloud computing module and HttpGet may be executed when the cloud computing module receives only a response like in Select.

As illustrated in FIG. 5, the smart power demand resources modeling data simulation module 300 may include a base model interface unit 310, a base simulation engine unit 320, an object model data handler 330, a simulation modeling manager 340, a smart economic analysis algorithm engine unit 350, and a modeling simulation web controller 360.

The smart power demand resources modeling data simulation module 300 may call macroscopic modeling of national policy data regarding a stored power demand resources from a cloud computing module through the web application server, establish power demand resources modeling data so as to compare and analyze economics of a power demand management business project, and simulate and activate bidding data, winning bid data, profit data, and expense data of power demand resources, which are predicted under a power generation market of a power demand resources company, on a web image, based on the economic analysis result of the power demand management business project from the power demand resources modeling data.

The base model interface unit 310 may function as an interface for generating an object so as to use power demand resources modeling data and inputting information required for the power demand resources modeling data or outputting extracted information.

The base simulation engine unit 320 may configure an object type of a base model interface unit to extract information according to a simulation period of corresponding power demand resources modeling data and to manage resources required for driving simulation.

The object model data handler 330 may control an object model as an information exchange unit between a national virtual power plant business platform framework and a plug-in manager to drive simulation or execute a stoppage command.

The simulation modeling manager 340 may embody a data exchange component provided by the national virtual power plant business platform framework so as to exchange an object model with plug-in managers of other power demand resources modeling data and transmit power demand resources modeling data extracted from the object model to the smart economic analysis algorithm engine unit and the modeling simulation web controller.

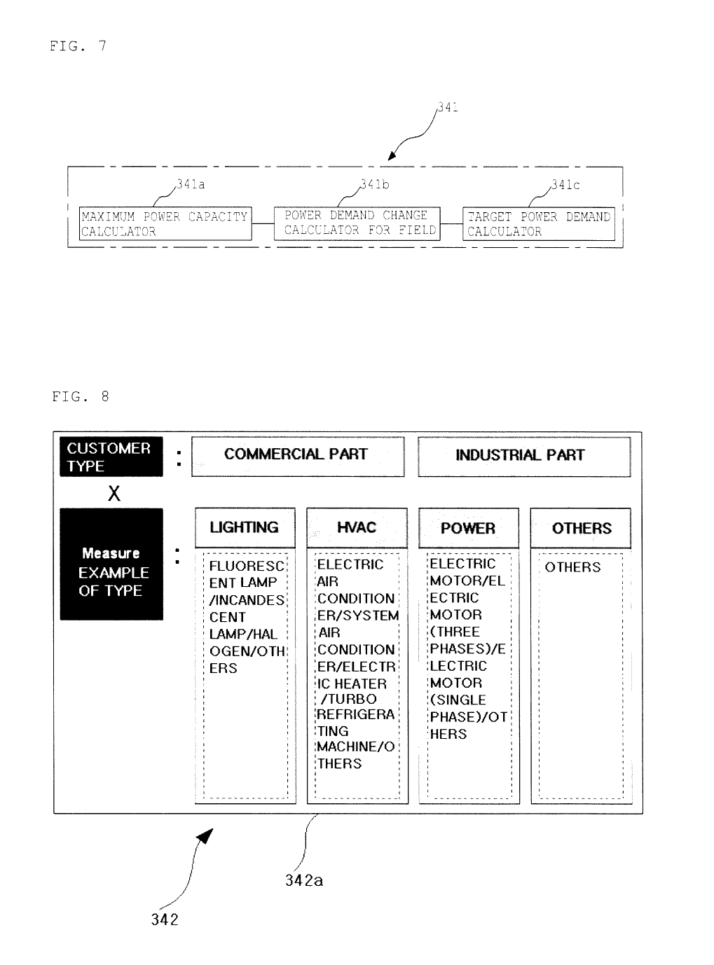

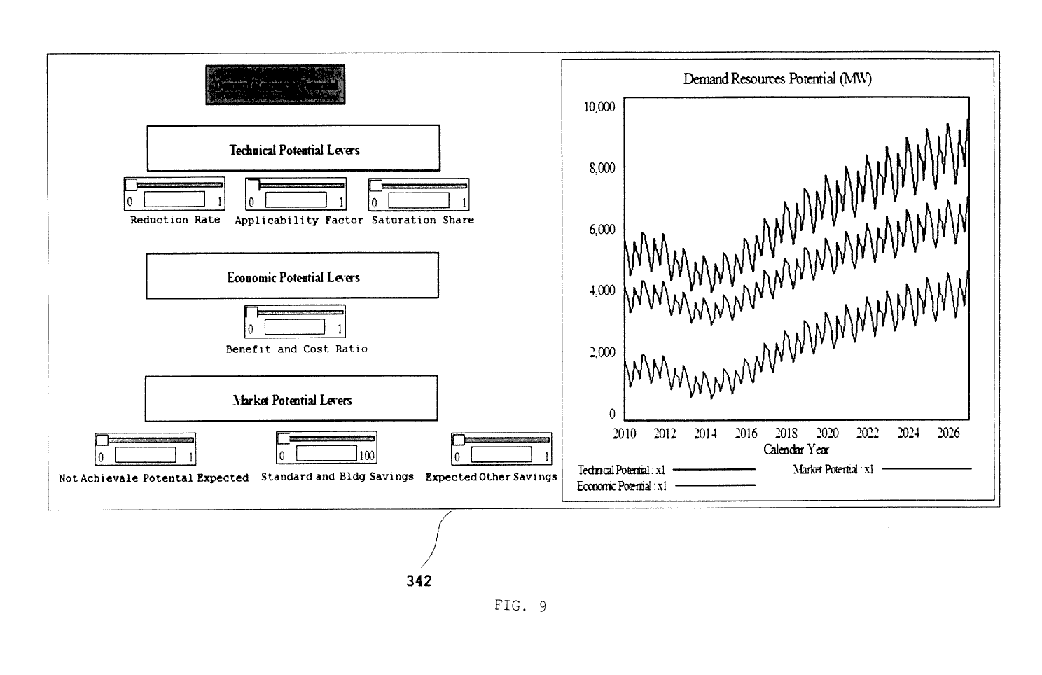

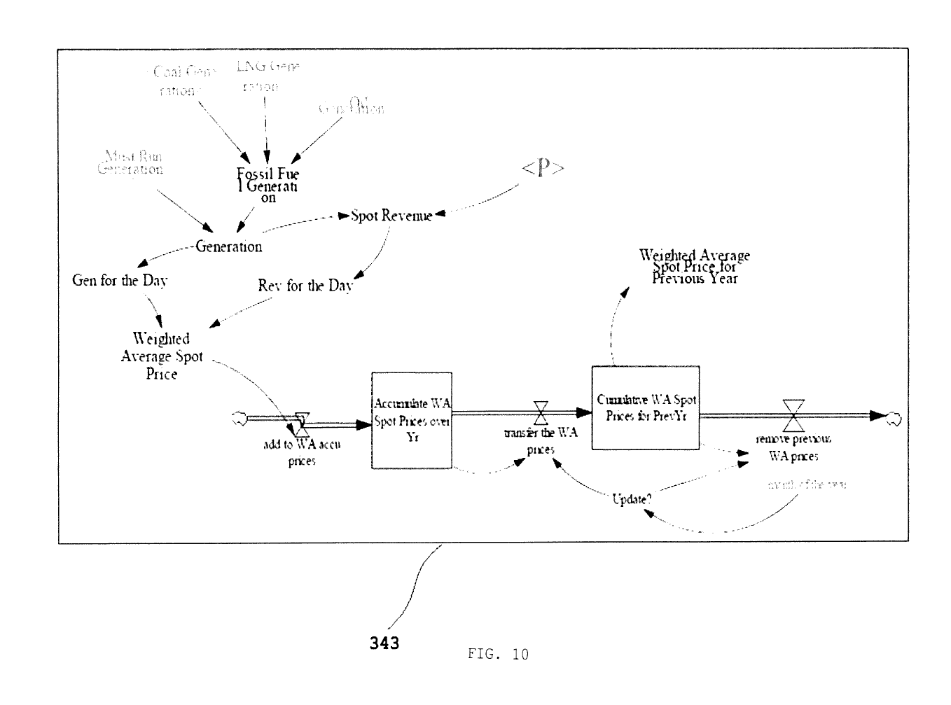

As illustrated in FIG. 6, the simulation modeling manager 340 may include one or more selected from a power demand estimation module 341, a power demand resources potential analysis module 342, a system marginal price (SMP) module 343, a power generation and demand resources market analysis module 344, a power demand resources effect analysis module 345, an automated demand response (ADR) module 346, and a group method of data handling (GMDH) module 347.

### Power Demand Estimation Module

The power demand estimation module 341 may classify power demand potential in commerce and industry, obtained by considering price elasticity, into load management saving, energy efficiency saving, and self-generation saving and calculate and analyze power demand based on a distribution ratio of past power consumption

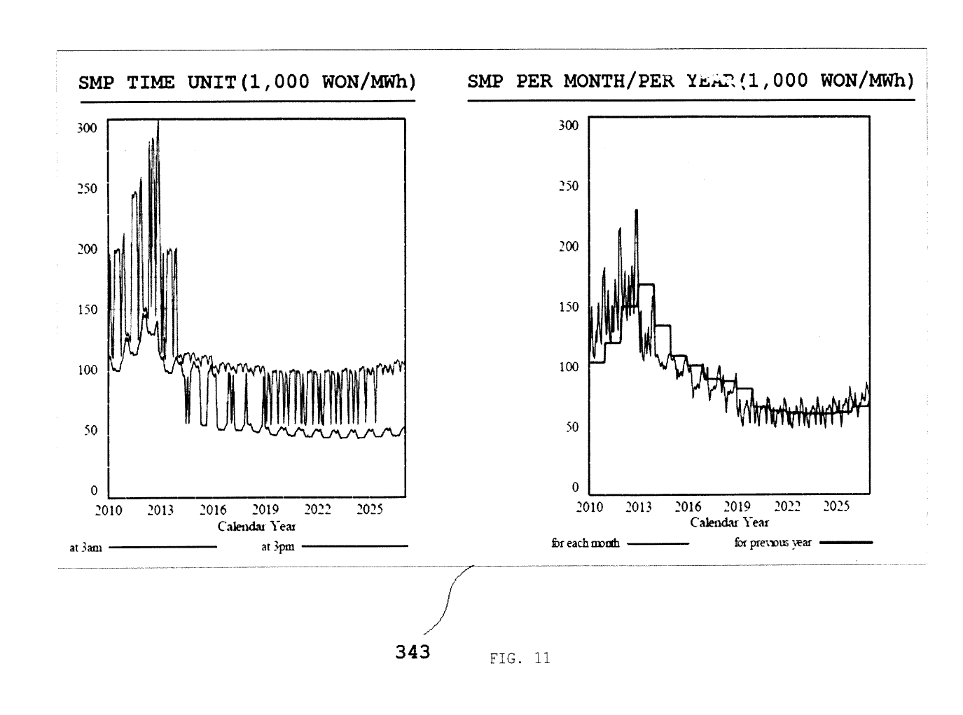

As illustrated in FIG. 7, the power demand estimation module 341 may include a maximum power capacity calculator 341a, a power demand change calculator 341b for a field, and a target power demand calculator 341c.

The maximum power capacity calculator 341a may calculate maximum power capacity of home, commercial, and industrial parts according to long-term trends.

The power demand change calculator 341b for a field may calculate a power demand change for each field according to a power price change.

The target power demand calculator 341c may calculate power demand in consideration of maximum potential amount and target savings for each demand management type.

### Power Demand Resources Potential Analysis Module

The power demand resources potential analysis module 342 may analyze potential of power demand management based on power demand potential obtained by considering a rate of economic growth and power price and consumption for each use and an energy saving estimation value predicted through self generation, among others.

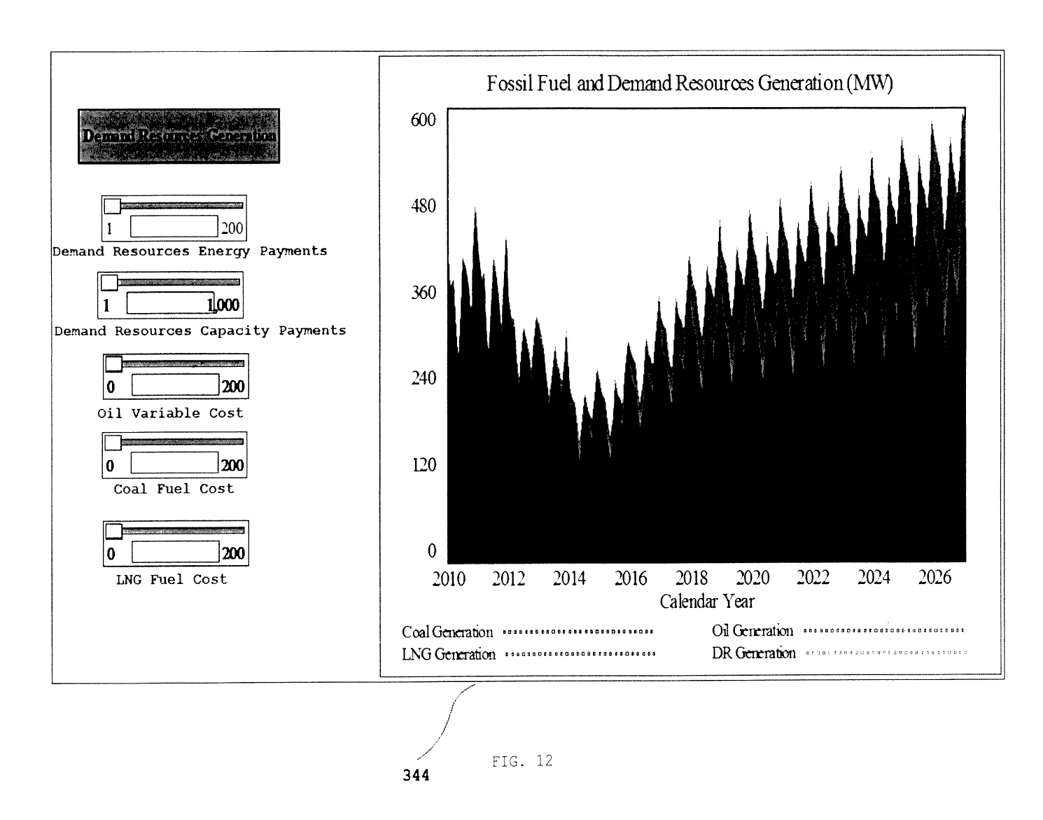

As illustrated in FIG. 8, the power demand resources potential analysis module 342 may include an energy efficiency program engine unit 342a.

The energy efficiency program engine unit 342a may classify a client type according to housing, commercial, and industrial parts and classify power consumption of an electric device used for each client type into technical potential, economical potential, and maximum achievement potential so as to analyze potential.

Here, the technical potential may refer to predicted saving potential obtained by applying an energy efficiency program to a whole market, the economical potential may refer to saving potential according to an energy efficiency program for determining a technical potential estimation value to be economical to both a consumer and a power generating company among technical potential estimation values, and the maximum achievement potential may refer to an estimated value obtained by predicting a demand factor and participation rate of an energy program of an end-user for each field by applying an incentive level and economic resources to the technical potential.

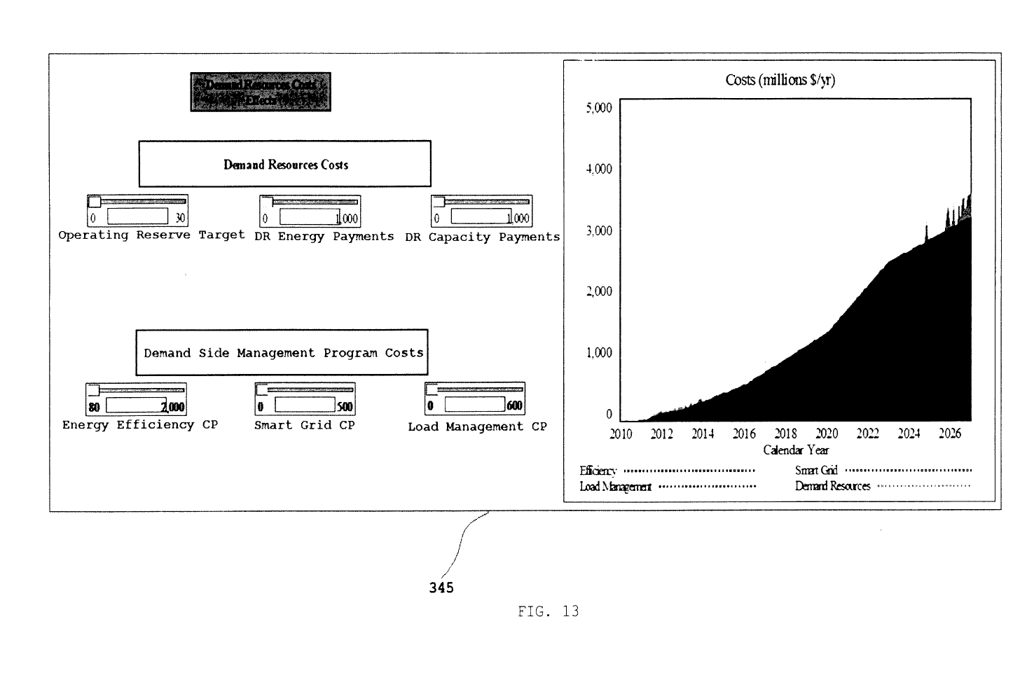

FIG. 9 is a diagram illustrating a graph of an estimation result of power demand resources potential by the power demand resources potential analysis module 342 according to the present invention.

### SMP Module

The SMP module 343 may simulate power demand resources and power generating resources so as to equally circulate to each other through modeling calculated based on a highest variable ratio and power generation rate of injected fossil fuel generating resources while a power generation rate for each fossil fuel generating resources (coal, LNG, and petroleum) to peak demand except for base load is formed.

As illustrated in FIG. 10, the SMP module 343 may include a peak load generating rate, a weight average SMP, a time unit SMP, and a month/year SMP, for each power generating source (coal. LNG, and petroleum).

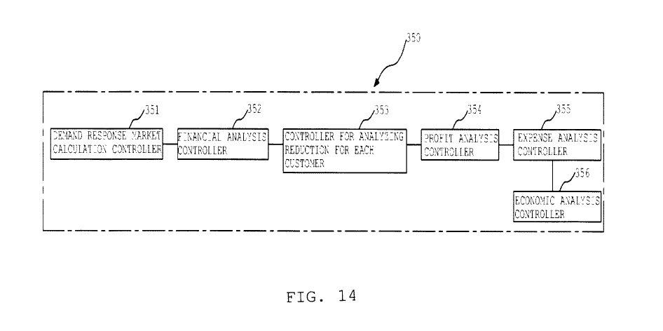

As illustrated in FIG. 11, the time unit SMP and the month/year SMP may be graphed and modeled as an SMP price estimation result.

### Power Generation and Demand Resources Market Analysis Module

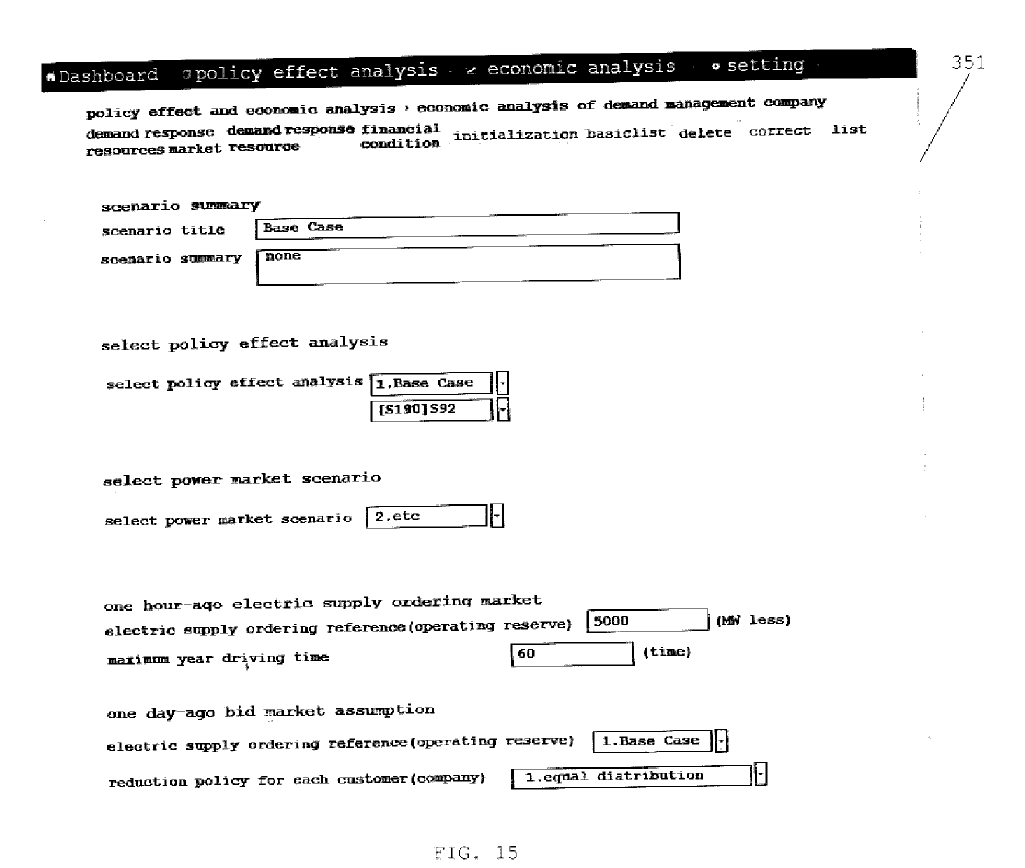

FIG. 12 is a graph illustrating estimation results of power demand resources and fossil fuel power generation through a power generation and demand resources market analysis module according to the present invention.

The power generation and demand resources market analysis module 344 may add power demand resources to an existing power market and analyze a power generating market in which power is generated via competition with fossil fuel generating resources.

The power generation and demand resources market analysis module 344 may be configured to classify power generating resources into base power generating resources and fossil fuel power generating resources in order to minutely analyze the power generating resources.

The base power generating resources may include hydroelectric, pumped hydro, nuclear power, renewable energy, and integrated energy generating resources, and the fossil fuel power generating resources may include coal, petroleum, and LNG power generating resources.

The power generation and demand resources market analysis module 344 may be configured to design a logic method for analysis of Auto-DR resources traded on a market, with respect to the power demand resources.

That is, the power generation and demand resources market analysis module 344 may be configured to supply power demand resources to a market when power generating reserve is degraded to a predetermined level (4,500,000 kW) or less and to generate power with resources in an order from a highest competitive price (in an order from a lowest variable ratio), which is determined via competition with fossil fuel power generating resources (fossil fuel, LNG, and petroleum) with respect to required power generation except for the base power generating resources.

The power generation and demand resources market analysis module 344 may be configured to induce prediction of power generation of water power, pumped hydro, nuclear power, and renewable energy in consideration of load patterns for each month and time, utilization factor, accidents for each season, and a planned discontinuance rate, according to the characteristics of each power generating source, and to induce prediction of power generation of fossil fuel power generating resources via competition of demand resources.

### Power Demand Resources Effect Analysis Module

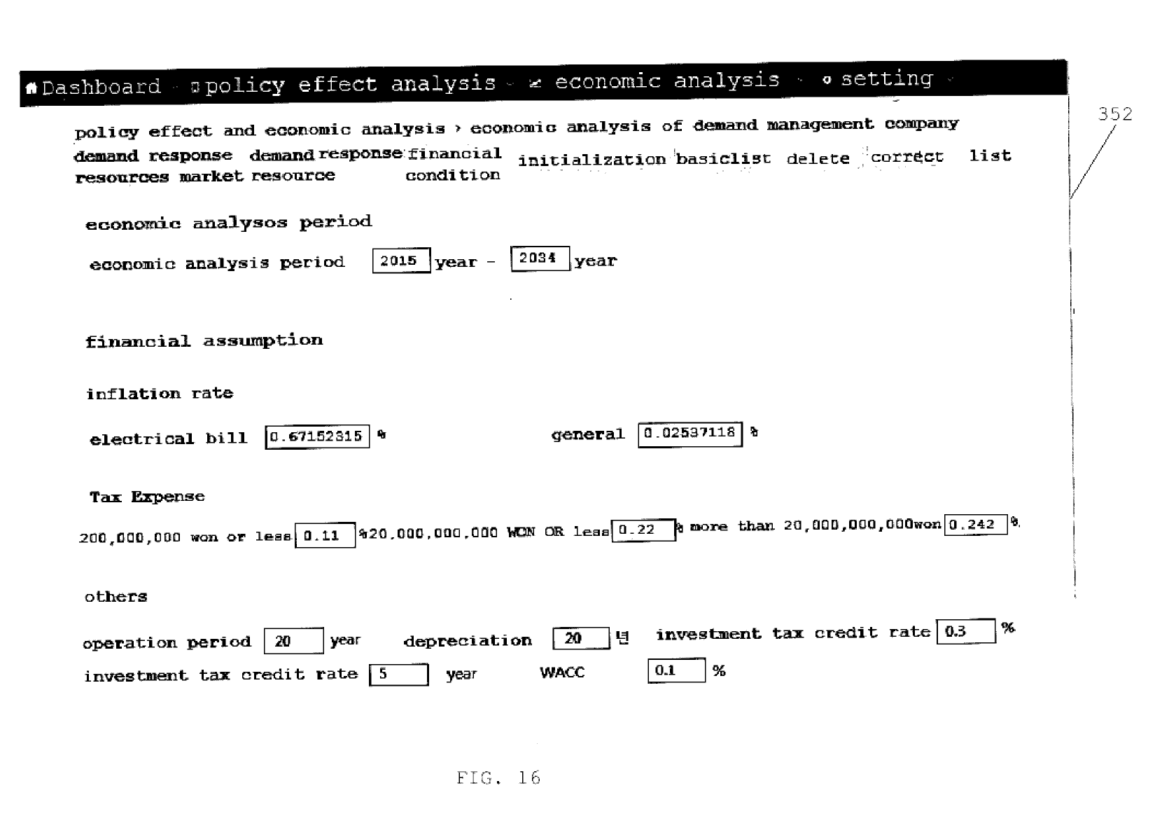

FIG. 13 is a graph illustrating an estimation result of cost effect of power demand resources through the power demand resources effect analysis module 345 according to the present invention.

The power demand resources effect analysis module 345 may estimate profit and existing demand managing program operating expense of a load aggregator (LA) for selling power demand resources, which are generated as the power demand resources are traded on a power market, power generating expense, power transmission and distribution expense, and operating expense (OPEX) of a power transmission and distribution company and predict and analyze unit cost of power according to profit of the power transmission and distribution company.

The power demand resources effect analysis module 345 may classify a unit of analysis of a power generating company and a demand resources company and configure a detailed analysis logic method for each company.

That is, the power demand resources effect analysis module 345 may classify a unit of analysis so as to minutely analyze each load aggregator (LA) as a demand resources company and each of Korea Electric Power Corporation (Korea Electric Power Corporation & Korea Hydro and Nuclear Power Co. Ltd.), a local power generating station (Korea Midland Power Co. Ltd., Korea Southern Power Co. Ltd., Korea East West Power Co. Ltd., and Korea West Power Co. Ltd., a public corporation (Korea Water Resources Corporation and Korea District Heating Corp), a private power generating company (POSCO, GS EPS, GS Power, MPC Yulchon, SK E&C, and other private power generating company) as power generating companies.

The power demand resources effect analysis module 345 may be configured to compensate for capacity payment (CP) and a highest variable ratio of time for response to only a specific reference value with program expense of demand resources that are equally traded to power generating resources and to estimate profit for each load aggregator (LA) according to energy saving.

The power demand resources effect analysis module 345 may be configured to calculate program operating expense (OPEX) for prediction of energy saving based on capacity payment (CP) with respect to each of load management, smart grid, and energy efficiency programs.

In the case of power generating resources, the power demand resources effect analysis module 345 may be configured to predict profit for each power generating company based on present possession of power generating resources according to capacity payment (CP) and scheduled power payment of predicted power generation for each power generating source.

In addition, the power demand resources effect analysis module 345 may be configured to predict operating expense (OPEX) of Korea Electric Power Corporation as a single power transmission and distribution company, which contains power generating expense of power generating resources, reduction cost of demand resources, power transmission and distribution expense, and so on and to predict unit cost of power according to required profit and target profit of Korea Electric Power Corporation.

### ADR Module

The ADR module 346 of FIG. 6 may simulate power demand resources and power generating resources to equally circulate to each other through modeling of analyzing demand response (DR) market change and business opportunity according to a smart DR system that is being managed by the government from national policy data stored in a data storage module.

The ADR module 346 may be configured to analyze DR market change and business opportunity according to a smart DR system that is being executed by the current government to generate DR resources as one of existing resources, to generate relation logic in which SMP and power retail price affect each other, and to generate logic for cost effect analysis of reliable DR and economic DR.

### Group Method of Data Handling (GMDH) Module

The GMDH module 347 of FIG. 6 may simulate power demand resources and power generating resources to equally circulate to each other through modeling of considering an economic factor (GDP, export, import, number of employed people, economic activity research, and petroleum consumption) and a climate factor (mean temperature), which affect power demand.

As illustrated in FIG. 14, the smart economic analysis algorithm engine unit 350 according to the present invention may include a demand response market calculation controller 351, a financial analysis controller 352, a controller 353 for analyzing reduction for each customer, a profit analysis controller 354, an expense analysis controller 355, and an economic analysis controller 356.

The smart economic analysis algorithm engine unit 350 may compare and analyze economics of a power demand management business project based on preset power demand resources modeling data according to input power demand management business project data and, then, transmit the comparing and analyzing result to a modeling simulation web controller.

The smart economic analysis algorithm engine unit 350 may include a Gauss program engine unit so as to automatically perform all calculation operations and may be configured to embody a graphical user interface (GUI) through Visual C++.

The demand response market calculation controller 351 may perform control to calculate a power demand response market that is predicted according to an input value of power demand management business project data.

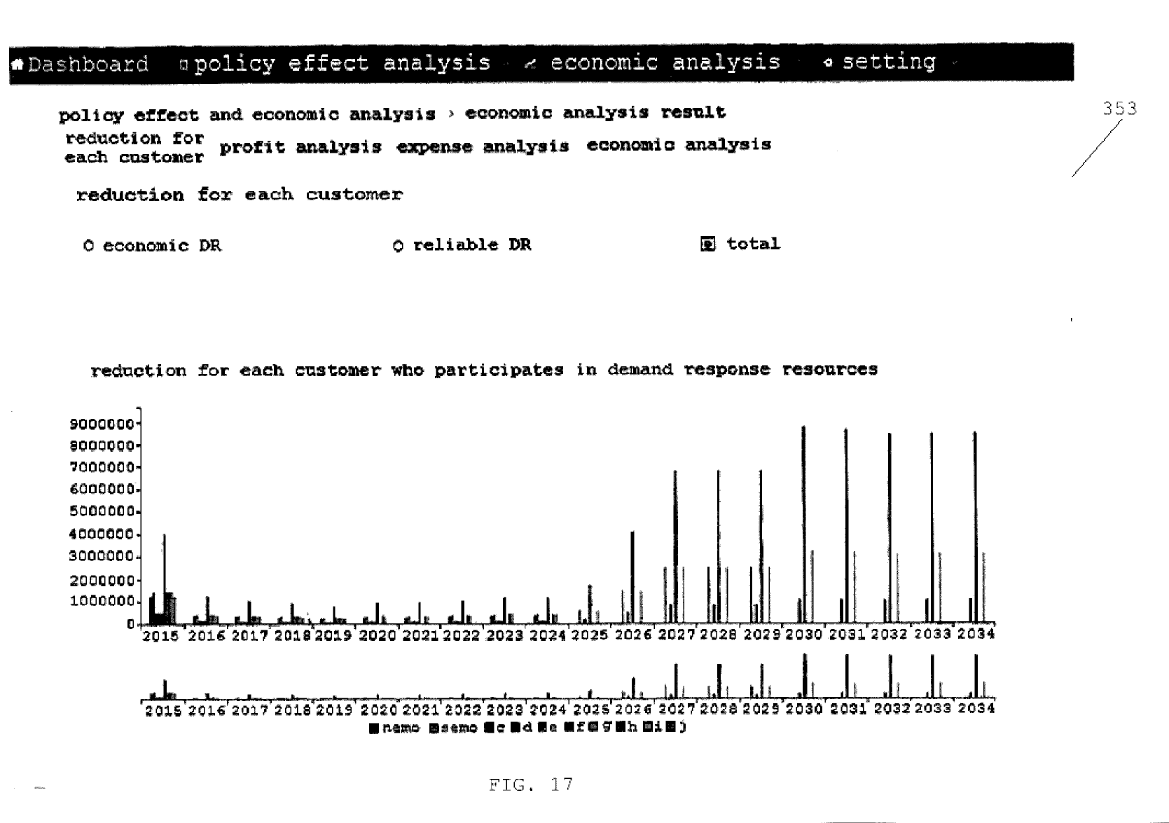

As illustrated in FIG. 15, the demand response market calculation controller 351 may include a scenario title input unit for inputting a scenario title of a power demand management business project, a scenario summary input unit for inputting scenario summary of the power demand management business project, an economic effect analysis selector for selecting economic effect analysis, a power market scenario assumption selector for selecting a power market scenario assumption state, a one hour-ago electric supply ordering market assumption input unit for inputting a one hour-ago electric supply ordering market assumption state, and a one day-ago bid market assumption state input unit for inputting a one day-ago bid market assumption state.

Upon receiving input data through the scenario input unit, the scenario summary input unit, the economic effect analysis selector, the power market scenario assumption selector, the one hour-ago electric supply ordering market assumption input unit, and the one day-ago bid market assumption state input unit, a demand response market calculation controller according to the present invention may perform control to compare and analyze the input data based on preset power demand resources modeling data and then to calculate a predicted power demand response market.

The financial analysis controller 352 may perform control to calculate a financial condition of power demand resources according to an input value.

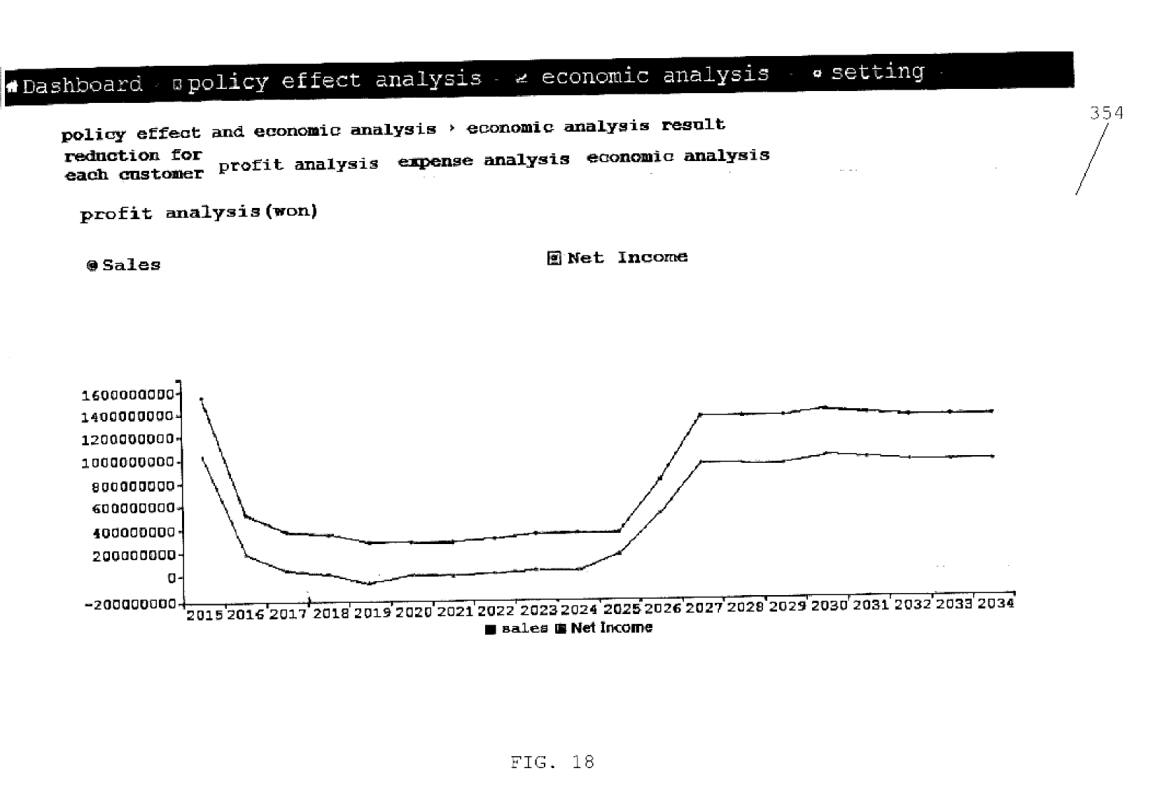

As illustrated in FIG. 16, the financial analysis controller 352 may include an economic analysis period input unit for inputting an economic analysis period, and a financial input unit for inputting a financial assumption state of an inflation rate, a corporate tax rate, an operation period, a depreciation period, an investment tax credit rate, an investment tax credit period, and WACC.

Upon receiving input data through the economic analysis period input unit and the financial input unit, a financial analysis controller according to the present invention may perform control to compare and analyze the input data based on preset power demand resources modeling data and then to calculate a predicted financial condition.

The controller 353 for analyzing reduction for each customer may perform control to compare and analyze reduction for each customer who participates in power demand resources based on preset power demand resources modeling data and then to transmit predicted reduction for each customer to a modeling simulation web controller.

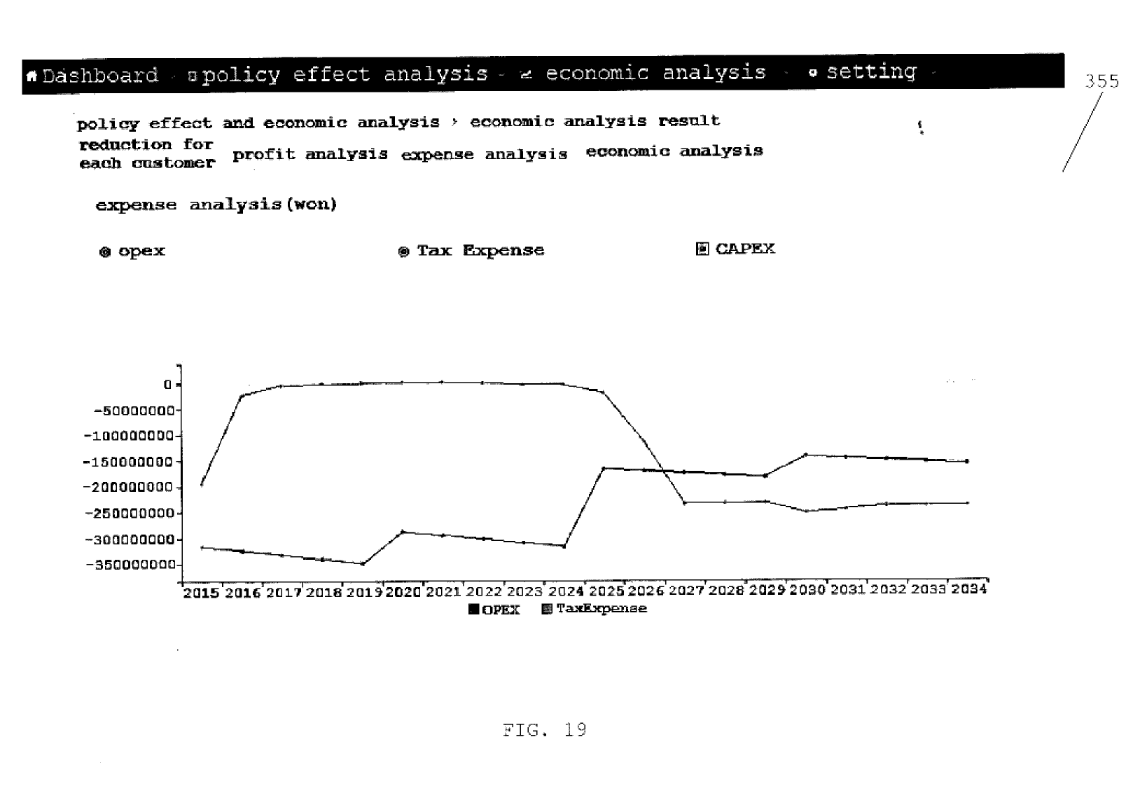

As illustrated in FIG. 17, the controller 353 for analyzing reduction for each customer may include an economic DR selector for selecting economic DR, a reliable DR selector for selecting reliable DR, and a total selector for selecting both the economic DR and the reliable DR.

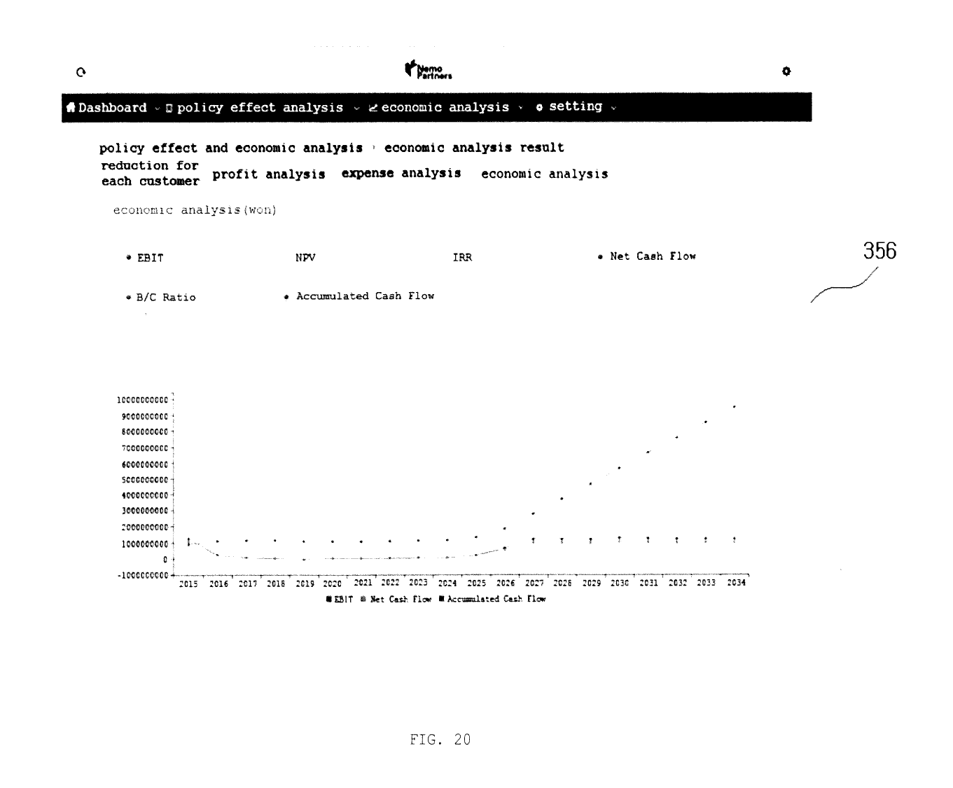

As illustrated in FIG. 18, when power demand resources according to the power demand management business project are sold on a market, the profit analysis controller 354 may perform control to compare and analyze input data based on preset power demand resources modeling data and then to transmit information on predicted sales and net income to the modeling simulation web controller.

As illustrated in FIG. 19, the expense analysis controller 355 may perform control to compare and analyze expense consumed for power demand resources according to the power demand management business project based on preset power demand resources modeling data and then to transmit information on predicted operating expense (OPEX), a corporate tax expense, and capital expense for future profit to the modeling simulation web controller.

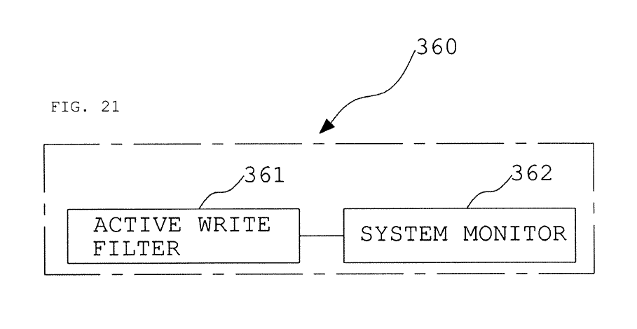

As illustrated in FIG. 20, the economic analysis controller 356 may perform control to compare and analyze economics of power demand resources according to the power demand management business project based on preset power demand resources modeling data and then to transmit predicted earnings before interest and taxes (EBIT), a net present value (NPV), an internal ratio of return (IRR), a net cash flow, a B/C ratio, and an accumulated cash flow to the modeling simulation web controller.

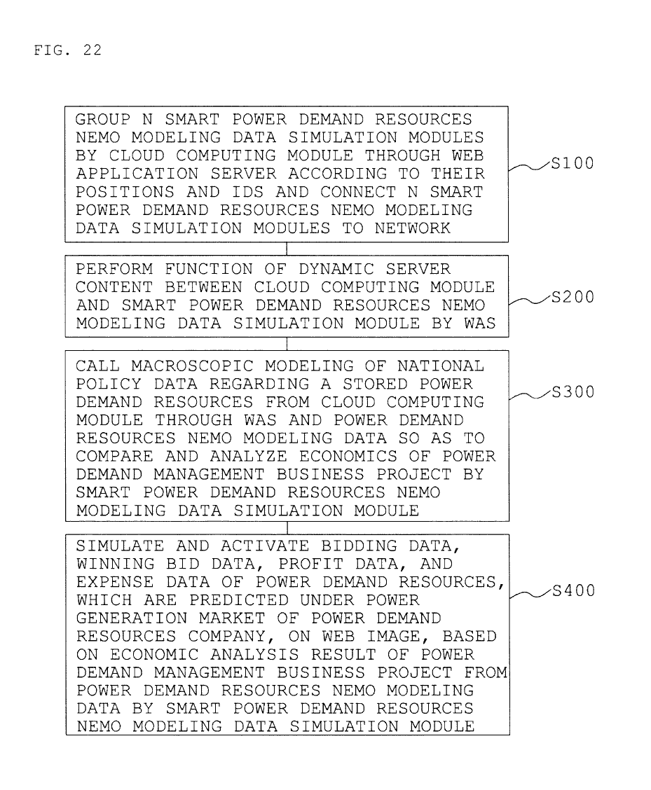

As illustrated in FIG. 21, the modeling simulation web controller 360 may include an active write filter 361 and a system monitor 362.

The modeling simulation web controller 360 may be installed as a program in a PC as a client object, may manage and control system recovery, OS recovery, real-time data backup of the PC as a client object in a network environment, and application software management during driving of modeling simulation, and may be operationally associated with a base model interface unit, a base simulation engine unit, an object model data handler, a simulation modeling manager, and a smart economic analysis algorithm engine unit to activate a result value on a screen of the PC as a client object.

The active write filter 361 may manage record of a filter, required during recovery, remove the filter, generate a new filter after reboot, and then generate the new filter in a virtual storage space.

The active write filter 361 may be applied to protect an OS image and may be configured to provide an active recovery environment according to a user environment and situation based on write filter technology of converting write access into an overlay space while operating as a function of converting a write operation of a protected partition into an overlay space to prevent writing of one volume between a physical disc volume and a file system.

An active write filter according to the present invention may divide a real storage region into partition regions and install OSs and backup images in the respective partition regions.

In addition, the partition space may be overwritten by the active write filter during an operation and may generate and manage a virtual storage space. The active write filter may be configured to operate and control all operations through a filter after booting.

The active write filter 361 may overwrite a filter on a drive of an execution region and form a virtual storage space so as to execute all operations after booting in the virtual storage space.

The active write filter 361 may be configured to remove a filter and generate a new filter after rebooting so as to recover a system in a very short period of time.

An active write filter according to the present invention may be loaded by a write filter driver while a system OS is booted and may be loaded by an active driver after the system OS is started.

The active driver may hook and monitor change in a file, a registry, directory, and so on and control reading and writing.

When the system is changed, that is, a file, a folder, a registry value, or the like is generated or changed, the system monitor 362 may automatically detect the change, may monitor the change on a screen, and may activate an economic analysis result of the power demand management business project in a web image.

The system monitor 362 may be configured to watch and monitor an event such as change in a system, data, registry, and so on and to embody a smart write filter.

That is, when a storage event for storage of a working document occurs, the system monitor 362 may be configured to detect the event via monitoring, to intercept the event, to generate a virtual path to D:partition from C:partition of the system OS, and to perform guidance to store data in the D:partition.

A system monitor according to the present invention according to the present invention may include a hooking driver for event monitoring.

Upon receiving a request for generating and updating a file, a directory, and a registry from a client, the hooking driver may detect an event signal generated by an OS according to system hooking and return and change the result value according to a chain driver function and a chain registry function of hooking logic.

When data is generated or corrected by an activated process, the hooking driver may automatically detect the data, and when data such as chunk data in a server file is present in a client, the hooking driver may transmit an index of the corresponding chunk to the client and update only files of a corresponding directory and lower directories.

The data may be classified in chunk data and checksum may be calculated. Then, only an updated portion may be searched for and updated in a client object, and the updated portion may be searched using MD5 checksum in order to rapidly search for a non-updated portion.

In addition, the system monitor may be configured to accurately determine whether data is generated or corrected and whether the data is generated or corrected at a point time when share violation is not applied (at a backup available point of time) in order to backup real-time network data.

The system monitor 362 according to the present invention may include an economic analysis result display controller 362a.

The economic analysis result display controller 362a may simulate and activate bidding data, winning bid data, profit data, and expense data of power demand resources, which are predicted under a power generation market of a power demand resources company, on a web image, based on the economic analysis result of the power demand management business project through the smart economic analysis algorithm engine unit 350.

The economic analysis result display controller 362a may be associated with the controller 353 for analyzing reduction for each customer, the profit analysis controller 354, the expense analysis controller 355, and the economic analysis controller 356, which are components of the smart economic analysis algorithm engine unit.

As such, the modeling simulation web controller 360 including the active write filter 361 and the system monitor 362 may be configured so as to reduce several tens to several minutes taken for system recovery in an existing solution to several seconds and to reduce loss in valid data of a user during recovery by achieving 80% compared with a conventional apparatus through network backup technology.

In addition, a system may be configured to reduce loss according to expense and a vacuum in business, which are caused due to recovery, through real time recovery for enhancing data backup efficiency using index compare backup technology instead of conventional complete backup technology of total comparison during network backup and to cope with an unwarranted intrusion such as access of a user who is not authenticated and exposure of personal information in a plurality of network environments.

Hereinafter, a method of analyzing economics of a power demand management business project through a smart power demand resources modeling data simulation module according to the present invention will be described.

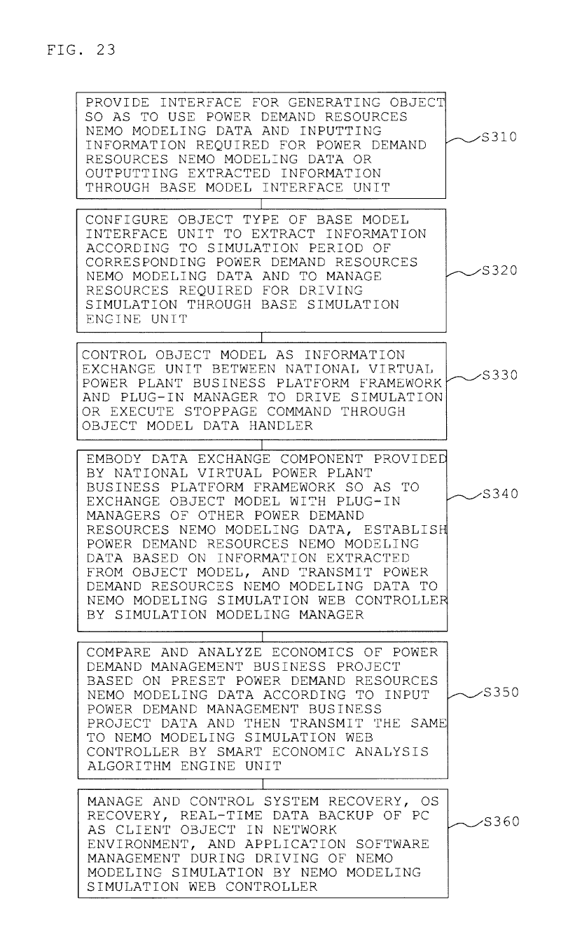

First, as illustrated in FIG. 22, N smart power demand resources modeling data simulation modules may be grouped by the cloud computing module 100 through a web application server according to their positions and IDs and may be connected to a network (S100).

Then, dynamic server content between the cloud computing module and the smart power demand resources modeling data simulation module may be executed by the WAS 200 (S200).

Then, the smart power demand resources modeling data simulation module 300 may call macroscopic modeling of national policy data regarding a stored power demand resources from a cloud computing module through the WAS and establish power demand resources modeling data so as to compare and analyze economics of a power demand management business project (S300).

Lastly, the smart power demand resources modeling data simulation module 300 may simulate and activate bidding data, winning bid data, profit data, and expense data of power demand resources, which are predicted under a power generation market of a power demand resources company, on a web image, based on the economic analysis result of the power demand management business project from the power demand resources NEMO modeling data (S400).

As illustrated in FIG. 23, the smart power demand resources modeling data simulation module 300 may provide an interface for generating an object so as to use power demand resources modeling data and inputting information required for the power demand resources modeling data or outputting extracted information through a base model interface unit (S310).

Then, the smart power demand resources modeling data simulation module 300 may configure an object type of the base model interface unit to extract information according to a simulation period of corresponding power demand resources modeling data and to manage resources required for driving simulation through a base simulation engine unit (S320).

Then, the smart power demand resources modeling data simulation module 300 may control an object model as an information exchange unit between a national virtual power plant business platform framework and a plug-in manager to drive simulation or execute a stoppage command through an object model data handler (S330).

Then, a simulation modeling manager may embody a data exchange component provided by the national virtual power plant business platform framework so as to exchange an object model with plug-in managers of other power demand resources modeling data, establish power demand resources modeling data based on information extracted from the object model, and transmit the power demand resources modeling data to a modeling simulation web controller (S340).

Then, the smart economic analysis algorithm engine unit 350 may compare and analyze economics of a power demand management business project based on preset power demand resources modeling data according to input power demand management business project data and, then, transmit the same to a modeling simulation web controller (S350).

Then, a modeling simulation web controller may manage and control system recovery, OS recovery, real-time data backup of the PC as a client object in a network environment, and application software management during driving of moxleling simulation (S360).

As is apparent from the above description, the present invention, as disclosed, may reduce database load according to economic analysis information by processing massive and high-performance data between the web and a cloud sever and distributively storing the data as a database through a web cloud computing environment and may automatically predict power market price and variable profit according to saving of power demand so as to analyze influence with high accuracy of purchase cost of power, may predict a time zone in which power market price sharply rises and pre-manage power demand so as to guide reduction in power market price and to reduce purchase cost of power, may ensure technology of predicting power demand and determining power market price on a power market to which current variation is not applied and may accurately manage power demand resources in real time so as to upgrade a technical level of managing national power demand, and above all, may allow national power demand resources companies to actively participate in a national power market to create profit via an economic analysis result of power demand management business project, which is performed in real time.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for analyzing economics of a power demand management business project using a smart power demand resources modeling data simulation module, the apparatus comprising:
a cloud computing module for grouping N smart power demand resources modeling data simulation modules according to their positions and IDs through a web application server and connecting the modules to a network;
a web application server (WAS) positioned between a cloud computing module and a smart power demand resources modeling data simulation module and for supporting bidirectional data communication so as to perform a function of dynamic server content between the cloud computing module and the smart power demand resources modeling data simulation module; and
a smart power demand resources modeling data simulation module for calling macroscopic modeling of national policy data regarding a stored power demand resources from the cloud computing module through the web application server, establishing power demand resources modeling data so as to compare and analyze economics of the power demand management business project and then simulating and activating bidding data, winning bid data, profit data, and expense data of power demand resources, predicted under a power generation market of a power demand resources company, on a web image, based on an economic analysis result of the power demand management business project from the power demand resources modeling data.

2. The apparatus according to claim 1, wherein the cloud computing module comprises:
a cloud tester for examining error and safety of the smart power demand resources modeling data simulation module so as to directly examine the smart power demand resources modeling data simulation module;
a database unit connected to a business platform server for a national virtual power plant so as to collect technology data of the national virtual power plant, connected to a server of a government organization so as to collect national policy data of power demand resources, shared data of government organizations, domestic power demand resources estimation modeling data, and overseas power demand resources estimation modeling data, for storing a winning bid situation DB for each ordering company, a winning bid situation DB for each license, a winning bid situation DB for each region, a winning bid situation DB for each sum of money, a winning bid situation DB for each quarter, a winning bid situation DB for each month, and a winning bid situation DB for each opening bid time based on a power demand management business project and then providing a required database;
a cloud data controller for applying clouding computing technology to provide a cloud service to the smart power demand resources modeling data simulation module, to detect continuous malicious code and virus of the smart power demand resources modeling data simulation module, and to store an authentication code of a user of a power demand resources modeling data simulation module; and
a cloud software development kit (SDK) unit for generating a new smart power demand resources modeling data simulation module to be overwritten to update the smart power demand resources NEMO modeling data simulation module by establishing, editing, and correcting a development environment of the smart power demand resources modeling data simulation module according to user purpose and then transmitting the new smart power demand resources modeling data simulation module to the smart power demand resources modeling data simulation module to be overwritten to update the smart power demand resources modeling data simulation module.

3. The apparatus according to claim 1, wherein the smart power demand resources modeling data simulation module comprises:
a base model interface unit for providing an interface for generating an object so as to use power demand resources modeling data and inputting information required for the power demand resources modeling data or outputting extracted information;
a base simulation engine unit for configuring an object type of the base model interface unit to extract information according to a simulation period of corresponding power demand resources modeling data and to manage resources required for driving simulation;
an object model data handler for controlling an object model as an information exchange unit between a national virtual power plant business platform framework and a plug-in manager to drive simulation or execute a stoppage command;
a simulation modeling manager for embodying a data exchange component provided by the national virtual power plant business platform framework so as to exchange an object model with plug-in managers of other power demand resources modeling data and transmitting power demand resources modeling data extracted from the object model to a smart economic analysis algorithm engine unit and a modeling simulation web controller;
a smart economic analysis algorithm engine unit for comparing and analyzing economics of the power demand management business project based on preset power demand resources modeling data according to input power demand management business project data and then transmitting a the comparing and analyzing result to the modeling simulation web controller; and
a modeling simulation web controller installed as a program in a PC as a client object, for managing and controlling system recovery, OS recovery, real-time data backup of the PC as a client object in a network environment, and application software management during driving of modeling simulation, and operationally associated with a base model interface unit, a base simulation engine unit, an object model data handler, a simulation modeling manager, and a smart economic analysis algorithm engine unit to activate a result value on a screen of the PC as a client object.

4. The apparatus according to claim 3, wherein the smart economic analysis algorithm engine unit comprises:
a demand response market calculation controller for performing control to calculate a power demand response market predicted according to an input value of power demand management business project data;
a financial analysis controller for performing control to calculate a financial condition of power demand resources according to an input value;
a controller for analyzing reduction for each customer, for performing control to compare and analyze reduction for each customer who participates in power demand resources based on preset power demand resources modeling data and then to transmit predicted reduction for each customer to a modeling simulation web controller;
a profit analysis controller for performing control to compare and analyze input data based on preset power demand resources modeling data and then to transmit information on predicted sales and net income to the modeling simulation web controller when power demand resources according to the power demand management business project is sold in a market;
an expense analysis controller for performing control to compare and analyze expense consumed for power demand resources according to the power demand management business project based on preset power demand resources modeling data and then to transmit information on predicted operating expense (OPEX), a corporate tax expense, and capital expense for future profit to the modeling simulation web controller; and
an economic analysis controller for performing control to compare and analyze economics of power demand resources according to the power demand management business project based on preset power demand resources modeling data and then to transmit predicted earnings before interest and taxes (EBIT), a net present value (NPV), an internal ratio of return (IRR), a net cash flow, a B/C ratio, and an accumulated cash flow to the modeling simulation web controller.

5. The apparatus according to claim 3, wherein the modeling simulation web controller comprises:
an active write filter for managing record of a filter, required during recovery, removing the filter, generating a new filter after reboot, and then generating the new filter in a virtual storage space, and for overwriting a filter on a drive of an execution region and forming a virtual storage space so us to execute all operations after booting in the virtual storage space; and
a system monitor for automatically detecting a change when a system is changed, that is, a file, a folder, a registry value, or the like is generated or changed, monitoring the change on a screen, and activating an economic analysis result of the power demand management business project in a web image.

6. A method for analyzing economics of a power demand management business project using a smart power demand resources modeling data simulation module, the method comprising:
grouping N smart power demand resources modeling data simulation modules according to their positions and IDs through a web application server and connecting the modules to a network;
executing dynamic server content between a cloud computing module and a smart power demand resources modeling data simulation module by a web application server (WAS);
calling macroscopic modeling of national policy data regarding a stored power demand resources from the cloud computing module through the web application server and establishing power demand resources modeling data so as to compare and analyze economics of the power demand management business project by a smart power demand resources modeling data simulation module; and
simulating and activating bidding data, winning bid data, profit data, and expense data of power demand resources, predicted under a power generation market of a power demand resources company, on a web image, based on an economic analysis result of the power demand management business project from the power demand resources modeling data by the smart power demand resources modeling data simulation module.

7. The method according to claim 6, wherein the establishing of the power demand resources modeling data comprises:
providing an interface for generating an object so as to use power demand resources modeling data and inputting information required for the power demand resources modeling data or outputting extracted information by a base model interface unit;
configuring an object type of the base model interface unit to extract information according to a simulation period of corresponding power demand resources modeling data and to manage resources required for driving simulation by a base simulation engine unit;
controlling an object model as an information exchange unit between a national virtual power plant business platform framework and a plug-in manager to drive simulation or execute a stoppage command by an object model data handler;
embodying a data exchange component provided by the national virtual power plant business platform framework so as to exchange an object model with plug-in managers of other power demand resources modeling data, establishing power demand resources modeling data based on information extracted from an object model and, then, transmitting the power demand resources modeling data to a modeling simulation web controller by a simulation modeling manager;
comparing and analyzing economics of the power demand management business project based on preset power demand resources modeling data according to input power demand management business project data and then transmitting a the comparing and analyzing result to the modeling simulation web controller by a smart economic analysis algorithm engine unit; and
managing and controlling system recovery, OS recovery, real-time data backup of a PC as a client object in a network environment, and application software management during driving of modeling simulation by a modeling simulation web controller.
